(19) United States
(12) Patent Application Publication
(10) Pub. No.: US 2007/0283416 A1
(43) Pub. Date: Dec. 6, 2007

(54) SYSTEM AND METHOD OF ENHANCING USER AUTHENTICATION USING RESPONSE PARAMETERS

(76) Inventor: Martin Renaud, Maple Ridge (CA)

Correspondence Address: PERKINS COIE LLP;PATENT-SEA, P.O. BOX 1247, SEATTLE, WA, 98111-1247, US

(21) Appl. No.: 11/737,692

(22) Filed: Apr. 19, 2007

Related U.S. Application Data
(60) Provisional application No. 60/797,718, filed on May 4, 2006.

(51) Int. Cl. H04L 9/32

(52) U.S. Cl. 726/2

(57) ABSTRACT

A software facility is disclosed that provides enhanced authentication of a user in a security system. During an initialization phase, the facility stores the responses of a user to a set of queries and also stores various parameters surrounding the responses. During an authentication session, the user is required to provide responses to at least some of the queries that were previously presented to the user in the initialization phase. Response parameters are measured as the user provides their responses during the authentication session. The identity of the user is verified by comparing the user's new responses to the queries with the stored responses to the queries. The identity of the user is also verified by comparing the recently-measured response parameters with the previously-stored response parameters.

### CROSS REFERENCE TO RELATED APPLICATIONS

This application claims priority to U.S. Provisional Patent Application No. 60/797,718, filed 4 May 2006, entitled “SYSTEM AND METHOD OF ENHANCING USER AUTHENTICATION THROUGH ESTIMATION OF FUTURE RESPONSE PATTERNS.”

### BACKGROUND

Security systems exist to help protect valuable electronic information, to restrict access to confidential areas, and to otherwise secure virtual or physical locations. Many existing security systems employ one of three security models: (1) using information that the user knows (e.g., login name and password), (2) using something the user has (e.g., a smart card or token), or (3) using something physical about the user (e.g., the user's fingerprint, iris, voice pattern, etc.). Financial institutions have recently been required to employ two-factor authentication (security under two of the three models) to secure financial accounts. Securing financial accounts not only protects a user's money, but also can be used to fight crime, such as money laundering, diversion of funds to criminal or terrorist organizations, and so forth.

Problems exist with each of the above three security models. For example, users often forget their user name or passwords. Passwords can also be easily stolen, and resetting passwords can be labor intensive and costly. Physical tokens are not only expensive, but also can be lost or forgotten. Mass adoption of physical tokens can be difficult because user resistance is high, and users may require separate tokens for each financial institution. The maintenance and tracking of physical tokens is even more labor intensive and costly than it is for passwords. Biometric systems are quite costly, impractical for many users/locations, and those that are less costly tend to be less secure.

As a result, a fourth type of security model has recently gained increased attention. In the fourth type of security model, often referred to as a knowledge-based authentication system, a user's unique experience or knowledge is used to authenticate a user and allow access to a protected resource. In some knowledge-based authentication systems, a user is required to respond to a series of queries pertaining to a subject matter that the user is familiar with. A profile is stored of the user's responses to the queries. The user is subsequently authenticated if the user is able to replicate the responses that are stored in the user's profile. Such a system is as simple and fast to use as passwords, while at the same time avoiding many of the shortcomings associated with passwords or technologies based on other security models. Even with their attendant advantages, however, knowledge-based authentication systems can suffer from certain forms of hacking attacks, such as keyloggers or shoulder surfing, that can ascertain the responses of a user to the queries. In addition, knowledge based authentication is susceptible to secret sharing. A shared password is no longer a secret between the user and a computer system. As a result, it would be advantageous to introduce another layer of verification in the system in addition to authentication based on duplication of the user's stored responses. That layer may incorporate a type of secret that the user is not consciously able to share, that enables the system to verify the identity of the user, and that does not increase the time needed for authentication. In addition it should be resistant to exact replication of a previous login event.

### BRIEF DESCRIPTION OF THE DRAWINGS

FIG. 1 is a block diagram of a computer that may employ aspects of an authentication system.

FIGS. 2A and 2B are block diagrams illustrating computing systems in which aspects of the authentication system may operate in a networked environment.

FIG. 3 is a representative screen shot of a query that may be presented to a user as part of an authentication of the user.

FIG. 4 is a flow chart of a process for measuring and storing response parameters associated with a user's response to a set of queries.

FIG. 5 is a data structure diagram showing sample contents of a data table that is used to store a user's responses to a set of queries and the response parameters associated with each of the responses.

FIG. 6 is a flow chart of a process for calculating a probability that new response parameters have been measured from the same user as a user that provided old response parameters.

### DETAILED DESCRIPTION

A software facility (the “facility”) is disclosed that provides enhanced authentication of a user in a security system. The facility operates in connection with a knowledge-based authentication system, such as the knowledge-based authentication system described in U.S. Provisional Patent Application No. 60/782,114, entitled “Authentication System Employing User Memories,” filed 13 Mar. 2006, which is hereby incorporated by reference in its entirety. During an initialization phase, the facility stores the responses of a user to a set of queries that are presented to the user and also stores various parameters surrounding the responses. The response parameters may include the rate, cursor movement pattern, or other characteristics of the user's responses. The responses and the response parameters are stored in a user profile associated with the user. During an authentication session, the user is required to provide responses to at least some of the queries that were previously presented to the user in the initialization phase. Response parameters are measured as the user provides their responses during the authentication session. The identity of the user is verified by comparing the user's new responses to the queries with the stored responses to the queries. The identity of the user is also verified by comparing the recently-measured response parameters with the previously-stored response parameters. Adding an additional level of authentication based on the response parameters enhances the overall security of the knowledge-based authentication system.

In some embodiments, the response parameters from each authentication session may also be stored by the facility in the user profile. Continuously updating the user profile with new data improves the performance of the authentication process, since the process will adapt to user variations over time. The response parameters may also be used by the facility to modify characteristics of the user interface during an authentication session. Modifications may be made to the presentation of information in each authentication session as a result of measured and predicted variations in the response parameters.

In some embodiments, in response to real-time changing security needs the facility is able to adjust the stringency of the test used to authenticate a user. In high-security applications the authentication process can require extremely stringent matching, while in low-security applications more relaxed matching may be provided. The authentication process can also be varied depending on the location of a user, the type of device that is being used by a user, or the perceived level of security needed within a particular environment as the environment changes. As a result of being able to statically or dynamically adjust the stringency of the authentication process, the facility may be tailored to a particular deployment environment. Such dynamic adjustment may be made in accordance with predefined rules or as a result of certain triggering events.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Representative Computing Environments

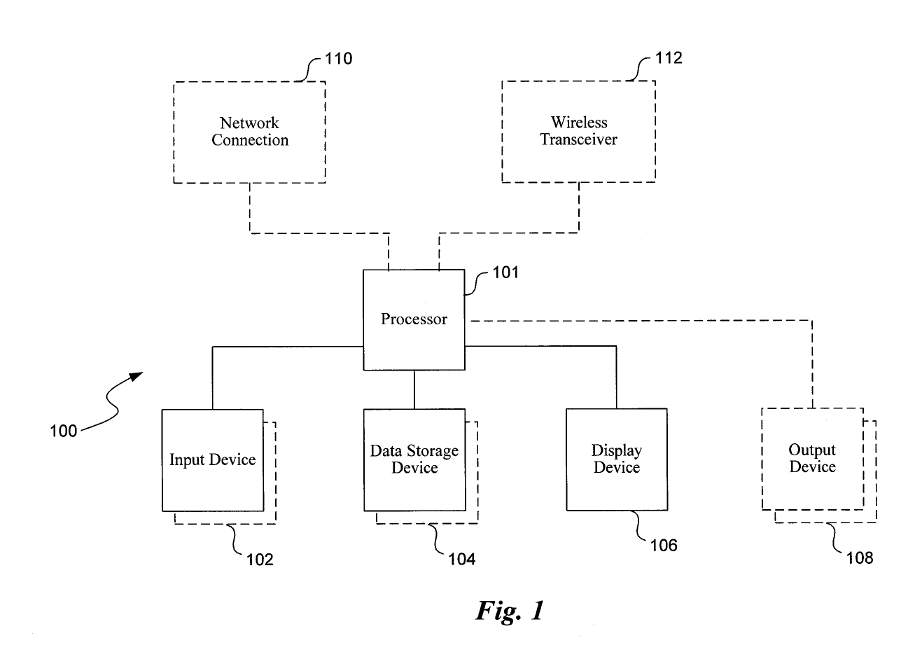

FIG. 1 and the following discussion provide a general description of a suitable computing environment or system in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and may be coupled to one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

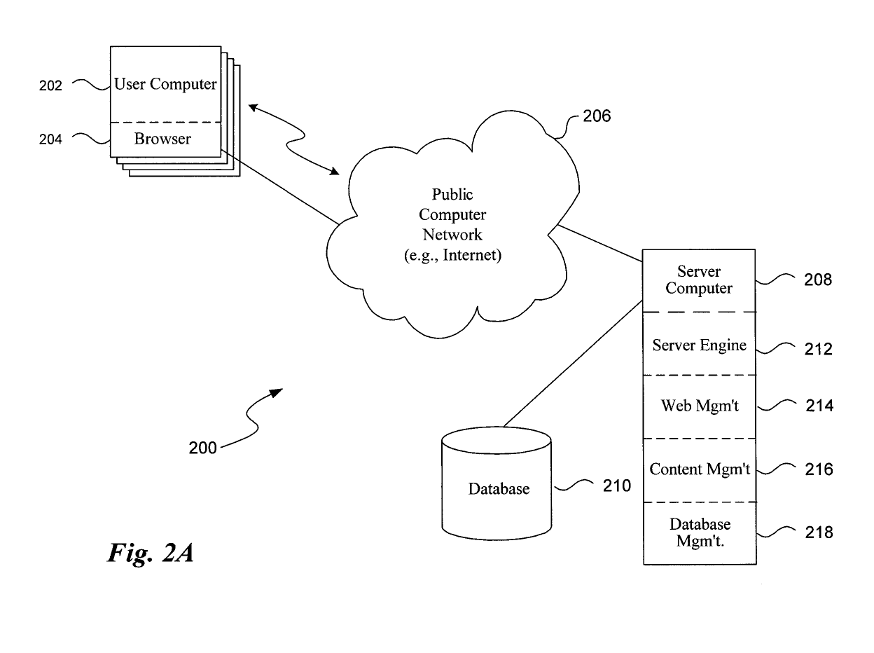

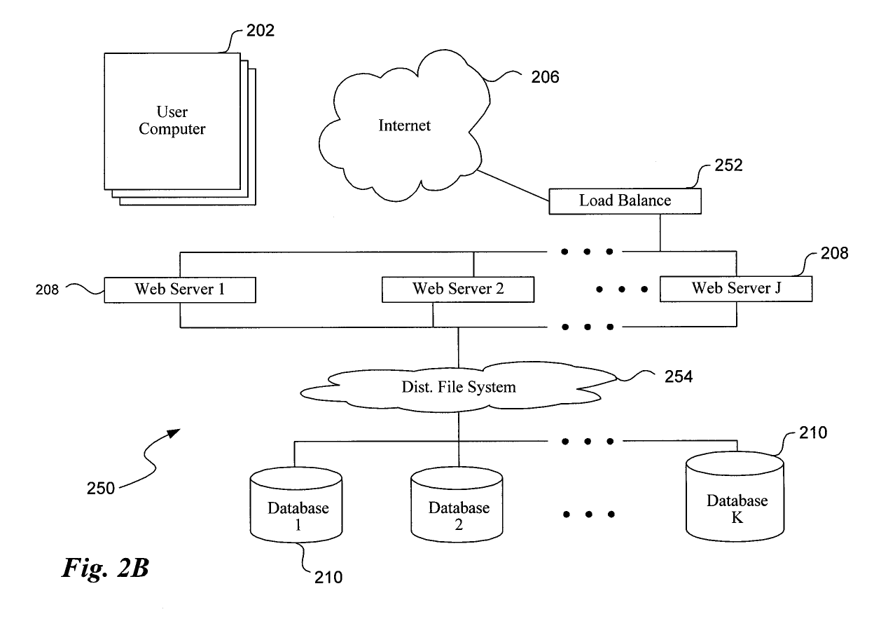

Aspects of the invention may be practiced in a variety of other computing environments. For example, referring to FIG. 2A, a distributed computing environment including one or more user computers 202 in a system 200 are shown, each of which includes a browser module 204. Computers 202 may access and exchange data over a computer network 206, including over the Internet to web sites within the World Wide Web. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical or other user interface to users may be employed.

At least one server computer 208, coupled to the network 206, performs much or all of the functions for receiving, routing and storing of electronic messages, such as web pages, audio signals, and electronic images. While a public network is shown, a private network, such as an intranet may be preferred in some applications. The network may have a client-server architecture, in which a computer is dedicated to serving other client computers, or it may have other architectures such as a peer-to-peer, in which one or more computers serve simultaneously as servers and clients. A database 210 or other storage devices, coupled to the server computer(s), stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

Referring to FIG. 2B, an alternative embodiment to the system 200 is shown as a system 250. The system 250 is substantially similar to the system 200, but includes more than one server computer (identified as web servers 1, 2, . . . J). A load balancing system 252 balances load on the server computers. Load balancing is a technique well-known in the art for distributing the processing load between two or more computers, to thereby more efficiently process instructions and route data. Such a load balancer can distribute message traffic, particularly during peak traffic times. A distributed file system 254 couples the web servers to several databases (shown as databases 1, 2, . . . K). A distributed file system is a type of file system in which the file system itself manages and transparently locates pieces of information (e.g., content pages) across the connected databases.

II. Authentication Process

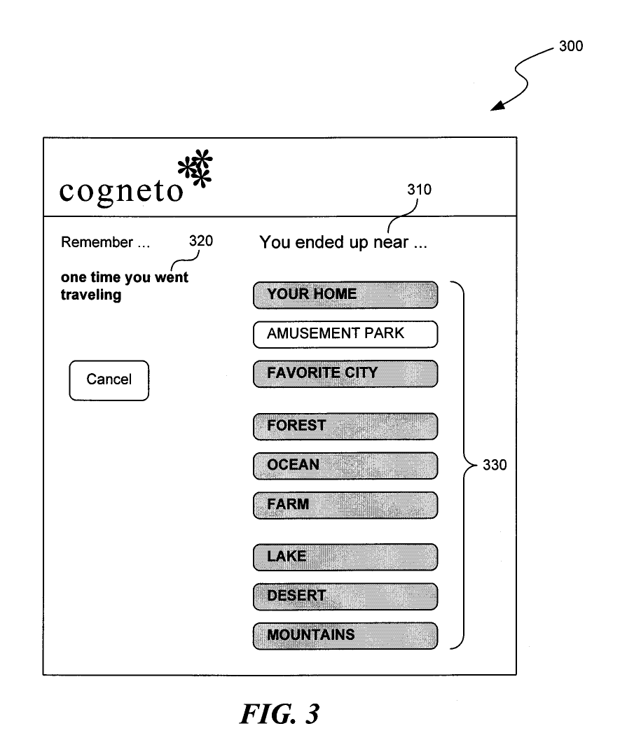

In one embodiment of the authentication process implemented by the facility, a user is presented with a set of queries about a theme that the user is familiar with. The theme may be a life event that the user has personally experienced, a category of information that is known to the user, a well-known event that the user is likely familiar with, or any other group of information that the user would be able to consistently recollect. The user's familiarity with the theme is captured by presenting the user with a set of queries related to that theme. As part of an initialization phase, the user's responses to the set of queries are stored as a user profile. FIG. 3 is a representative screenshot 300 of a sample query 310 that might be presented to a user during the initialization phase. The query 310 asks the user what location they “ended up near,” the question being related to a theme 320 about a time when the user went traveling. In the embodiment shown in FIG. 3, the user is presented with nine potential responses 330 and is asked to select a single response that best applies to the user. The response to the query is entered by a user using a mouse-over event, mouse click, keyboard entry, or other user input mechanism (e.g., touch screen, voice recognition). The response is stored in a user profile. After receiving a response, the next query is displayed to the user and the user's response stored. This process is continued until a sufficient number of queries have been displayed to a user to provide a desired level of security during an authentication session (which is described below). Further details about the use of themes and queries may be found in U.S. Provisional Patent Application No. 60/782,114, filed Mar. 13, 2006 (attorney docket no. 60783.8001.US00), which is hereby incorporated by reference in its entirety. Those skilled in the art will appreciate that the format of the query, the number of responses, and the manner of displaying the response may vary significantly from that shown in FIG. 3.

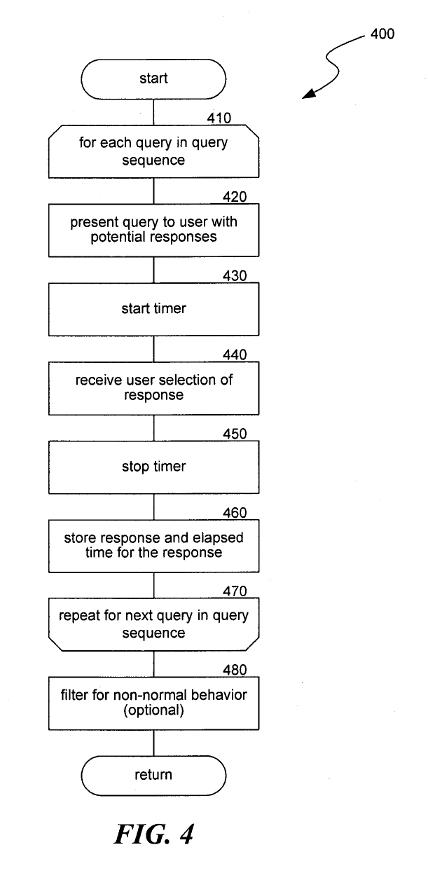

In addition to recording the user's responses to a set of queries, various response parameters are also measured and stored by the facility as the user is responding to the queries. A response parameter may include the time that it takes the user to enter a response, the movement of a cursor as the user enters a response (e.g., a cursor path between presentation of a query and receipt of the response), and other characteristics surrounding the user's response. FIG. 4 is a representative flow chart of a process 400 implemented by the facility to measure one type of response parameter (the elapsed time) associated with a user's response to each query in the set of queries. At a block 410, a loop is initiated to record a response parameter associated with each response received from a user. At a block 420, the facility presents a query to a user along with a set of potential responses to the query. At a block 430, a timer is started coincident with the presentation of the query to the user. At a block 440, the facility receives a selection of one of potential responses from the user. At a block 450, the timer is halted when the response is received from the user. At a block 460, the facility stores the response of the user and the elapsed time on the timer. The elapsed time represents the amount of time that it took the user to read a query, process the query, and select the appropriate response. In addition, the elapsed time may include any other delays due to inattentiveness, being distracted, computer error, or other error that the user may experience. At a block 470, the loop comprising blocks 420-460 is repeated in order to measure and store a response parameter representing the elapsed time for each of the queries that is presented to the user. While the elapsed time is the response parameter measured and stored in FIG. 4, those skilled in the art will appreciate that similar methodology may be used to measure and store other response parameters. For example, characteristics of the cursor movement as the user selects each response may be measured and stored instead of, or in addition to, the elapsed time. Other response parameters may also be recorded.

During the initialization phase, a user may be asked to respond to the same set of queries multiple times (each repetition referred to as an “initialization session”) in order for the facility to build an accurate user profile that contains the user's responses to the queries as well as representative response parameters associated with each of the queries. As a result, the process 400 may be repeated for each initialization phase session, with the response parameters associated with each session stored in the user's profile and utilized as set forth below. While the number of times that the queries need to be repeated will vary widely, in some embodiments of the facility it was found that approximately three to four sessions was sufficient to establish a baseline for a user.

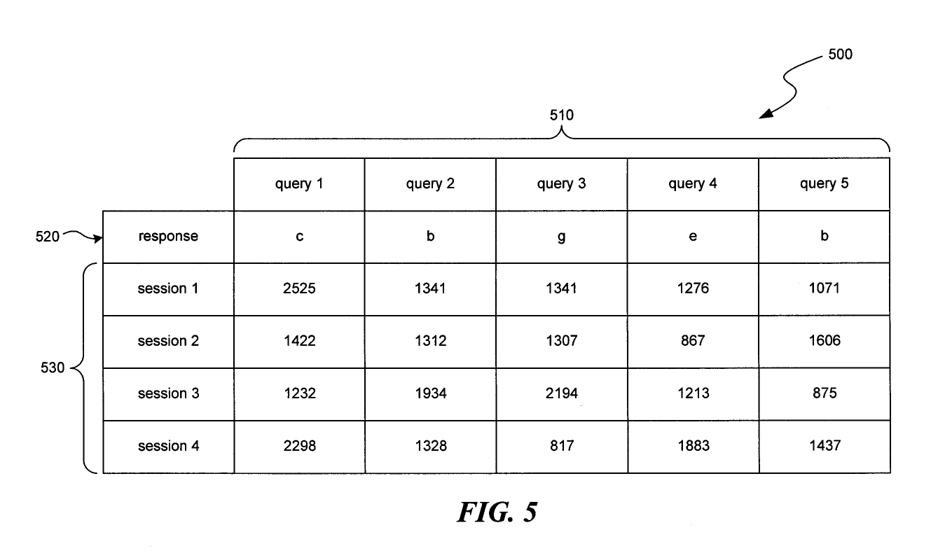

FIG. 5 is a representative data table 500 that may be utilized by the facility to store a user's responses to queries and the response parameters associated with each of the queries. Each column 510 in the table corresponds to one of the queries that is presented to a user in a particular initialization session. A row 520 in the table contains data reflecting the “correct” response to the query, as evidenced by the user consistently selecting that response during an initialization phase as being the most correct for a particular query. For example the user has identified response “g” as being the correct response for that user for query number three. One or more session rows 530 each contain the associated response parameter that is measured by the facility for each query. As depicted in table 500, the stored parameter is the time that it took for the user to respond to a particular query, measured in milliseconds. For example, in session 3 of the initialization phase, the user took 2.194 seconds to respond to query 3 of the session. Other response parameters, in addition to or in place of the elapsed time, may also be stored in the table 500.

While FIG. 5 depicts a table whose contents and organization are designed to make it more comprehensible to the human reader, those skilled in the art will appreciate that the actual data structure used by the facility to store this information may differ from the table shown. For example, the table may be organized in a different manner, may contain more or less information than shown, may be compressed and/or encrypted, and may otherwise be optimized in a variety of ways.

After the response parameters have been stored for a user, an optional step may be performed to check the reliability of the stored parameters. At an optional block 480, the response parameters are analyzed to identify any parameters that exceed a normal range for the parameter being measured. For example, it has been experimentally found that in a small number of sessions a user may become temporarily distracted or otherwise fail to respond to a query within a reasonable timeframe. A response time greater than a threshold time, such as five seconds, would indicate such a lapse in attention. When such a lapse occurs, the use of the measured response parameter becomes less reliable because the lapse is not a typical or repeatable event. Similarly, a very fast response time, such as 250 milliseconds, would suggest that the user did not read the options before entering a response. One technique to minimize the effect of such non-normal behavior is to apply a correction to such data. At block 480, the facility therefore examines all of the response parameters to see if any of the measured parameters are outside of the range of normal human responses. For example, if one of the response parameters exceeds the response time, the measured response parameter is not used in the subsequent equations and an average response parameter is used in its place. The average response parameter may be calculated using the mean of all of the measured response parameters associated with the same query as measured during different sessions. Alternatively, the average response parameter may be calculated using the mean of all of the other parameters associated with a single session. If more than one of the response parameters in a particular session exceeds the response time at block 480, all of the measured response parameters may be considered unreliable for that session. This would result in a decision that the session is corrupt, and the data was not likely to have come from the original user.

Once the initialization phase is complete, and sufficient information stored in the user's profile to establish a reliable baseline for the user, the information in the user profile may be used by the facility to authenticate the user on subsequent access requests (each such attempt referred to as an “authentication session”). In an authentication session the user is presented with a set of queries pertaining to a theme. The set of queries may be all of the queries displayed to the user in the initialization phase, of a subset of the set of queries, and may be displayed in the same or a different order to the user. Each displayed query includes a list of potential responses to the query. One of the list of potential responses is the response that the user previously entered to the query in the initialization phase. The other potential responses may be the same or different than those previously shown to the user in the initialization phase. A user is required to provide a response to each of the queries, and the response and parameters associated with the user's response are measured and stored by the facility. For example, the process depicted in FIG. 4 may be used to store the responses and the times associated with each user response. The response and response parameters are utilized by the facility as described below to authenticate, or deny authentication of, the user. Further details about an authentication session may be found in U.S. Provisional Patent Application No. 60/782,114, filed Mar. 13, 2006 (attorney docket no. 60783.8001.US00).

In the authentication session, the facility establishes a probability that a user requesting to be authenticated is the user represented by the user profile against which the requesting user is being tested. If the probability exceeds a certain threshold set by the facility operator, the user is considered to be authenticated (i.e., a “verified user”) and is allowed access to the resources protected by the facility. To ensure a high-degree of security, in some embodiments the user is verified on the basis of at least two components as reflected in the equation below:
P_{(Cognitive)}=P_{(Knowledge)}*P_{(Parameter)} Eq. (1)

P_{(cognitive)} is the overall probability that the user requesting to be authenticated is the user represented by the user profile. The overall probably is based on: (i) a knowledge component, P_{(Knowledge)}, which is the probability that the user seeking to be authenticated is the user represented by the user profile based on the responses to the set of queries received from the user; and (ii) a parameter component, P₍ₚₐᵣₐₘₑₜₑᵣ₎, which is the probability that the user seeking to be authenticated is the user represented by the user profile based on the measured response parameters associated with the user's responses. Including both components in the authentication process enhances the overall security of the knowledge-based authentication system.

The facility may implement the knowledge probability component of equation (1) as an “all-or-nothing” analysis. That is, a user may only be verified if the responses that they provide to the set of queries in the authentication phase exactly match the responses that they previously provided to the set of queries in the initialization phase. Missing a single response would result in verification of a user being denied. Such an approach, however, can be unduly restrictive and may not be suitable in some implementations where a certain degree of user error may be expected or allowed. As a result, in some embodiments of the facility the knowledge component is computed follows:

$${P}_{( Knowledge )} = \frac{1}{n} * {\sum }_{i = 1}^{n} P ( i ) \qquad Eq . ( 2 )$$

Where n equals the number of queries in the authentication session and P(i) is an assigned probability related to whether a response to a query was correct. That is, if the user answers a query correctly, P(i) for that query is set to 1.0. If the user answers a query incorrectly, P(i) for that query is set to a value reflective of the likelihood of an error occurring. For example, with reference to FIG. 4, it will be appreciated that nine potential responses are presented to the user, divided into three groups of three. With such a presentation, P(i) may be set to 0 if the user selects an incorrect response from a group of three that does not contain the correct response. P(i) may be set to 0.67, however, if the user selects an incorrect response in a group of three that does contain the correct response. The value 0.67 is computed as the likelihood of making a mouse click error when trying to quickly hit a target response in a group of three queries. In this fashion, a user is given partial credit for selecting the correct group, even though the correct response was not selected from the group due to factors such as user error. As an example, if five queries were included in an authentication session, the probability that a user who answers three queries correctly (i.e., their response matches the response in the user profile) and two queries incorrectly, but selected incorrect responses within groups of three that contained the correct response, is the verified user is therefore:

$$\begin{matrix}{P}_{( Knowledge )} = \frac{1}{n} * ( {P}_{( 1 )} + … + {P}_{( n )} ) \\ = 0.2 * ( 1.0 + 1.0 + 0.67 + 1.0 + 0.67 ) \\ = 0.868 , or roughly 87 \%\end{matrix}$$

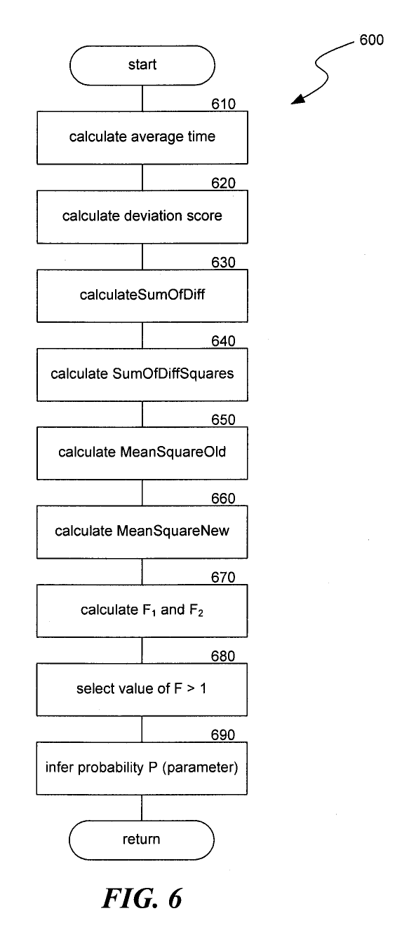

The facility may implement the parameter probability component of equation (1) in a variety of different ways. Broadly stated, the facility compares the response parameters for the user's authentication session with the response parameters for some or all previous sessions of the user in order to determine a probability that the user being authenticated is the same user as that associated with the user profile. Any processing that outputs a probability that the response parameters from the authentication session belong to the same statistical model as the response parameters in the user profile will therefore satisfy this requirement. In some embodiments, the facility uses the process 600 depicted in the flow chart of FIG. 6 to calculate the parameter probability component.

The process 600 compares the response parameters from the current authentication session with the response parameters from one or more previous sessions of the user in order to derive the parameter probability component of equation (1). At a block 610 in the first session, an average time is calculated from the response time in all the queries from the session. In subsequent sessions, if the response time is greater than the average time in the previous session multiplied by a correction factor (to correct for times that are outside the normal response range), the average time from the previous session will be utilized. If, on the other hand, the response time turns out to be smaller than the average time in the previous session multiplied by a correction factor, the following equation may be used to create a new average time.

$${calcAvgTime}_{curr} = \frac{{calcAvgTime}_{last} * n + {rt}_{curr}}{n + 1} \qquad Eq . ( 3 )$$

At a block 620, the user's deviation from typicality is calculated by determining the absolute value of the difference between the average response time and the current response time. At a block 630, a sum of the difference (sumOfDiff) is calculated in a manner that depends on the user's deviation from typicality. The conditional ensures that the estimates of response variability (the mean squares that will be calculated) are not exaggerated by outlier deviation scores. The sum of the difference is calculated in accordance with one of the following two equations:

$$\begin{matrix}sumOfDiff = {sumOfDiff}_{last} + \frac{{sumOfDiff}_{last}}{s} \\ if {Diff}_{current} > \frac{5 * {sumOfDiff}_{last}}{s} & Eq . ( 4 a ) \\ sumOfDiff = {sumOfDiff}_{last} + ⌊ \frac{{sumOfDiff}_{last} + {Diff}_{current}}{s + 1} ⌋ \\ if {Diff}_{current} < \frac{5 * {sumOfDiff}_{last}}{s} & Eq . ( 4 b )\end{matrix}$$

Where s equals the number of sessions from which data is being drawn and sumOfDiffₗₐₛₜ is the sumOfDiff from the previous session. At a block 640, the sumOfDiffSquares is calculated in accordance with the following equation:

$$sumOfDiffSquares = {sumOfDiffSquares}_{last} + {[ \frac{{sumOfDiff}_{current}}{s + 1} ]}^{2} \qquad Eq . ( 5 )$$

At a block 650, a mean squared calculation summarizes the variability in previous or old response parameters that are associated with the user in the user's profile. In some embodiments, the following equation can be used:

$$\begin{matrix}MeanSquareOld = \frac{1}{n} * \\ {\sum }_{i = 1}^{n} ⌊ \frac{1}{5 ( s + 1 ) - 1} * ( sumOfDiffSquares - \frac{{( sumOfDiff )}^{2}}{5 ( s + 1 )} ) ⌋\end{matrix} \qquad Eq . ( 6 )$$

Where n equals the number of queries in a session.

At a block 660, a mean squared calculation is made of the new parameters that were measured from the user responses during the authentication session. Once again, a correction is used to ensure that unusual responses don't have an unduly large influence on the outcome. In this case, the largest difference score is removed from the equation so that only the four typical scores affect the variability measure. In some embodiments, the following equation can be used:

$$\begin{matrix}MeanSquareNew = \frac{1}{3} * \\ ( \sum ( {{Diff}_{current}}^{2} ) {max ( Diff )}^{2} - \frac{{( \sum {Diff}_{current} - max ( Diff ) )}^{2}}{4} )\end{matrix} \qquad Eq . ( 7 )$$

At a block 670, the facility calculates two F values, F₁ and F₂. In some embodiments of the facility, the following equations are used:

$$\begin{matrix}{F}_{1} = \frac{MeanSquareNew}{MeanSquareOld} & Eq . ( 8 ) \\ {F}_{2} = \frac{MeanSquareOld}{MeanSquareNew} & Eq . ( 9 )\end{matrix}$$

One of the calculated F values will be greater than 1, and the other value will be less than 1. The F values correspond to a point on an appropriate F distribution and are a measure of the likelihood that the new response parameters came from the same user as the old response parameters as compared on a question-by-question basis. If the F values are relatively close to or equal to 1, then there is a strong correlation between the new response parameters and the old response parameters. If the F values are far apart, then there is a weak correlation between the new response parameters and the old response parameters. The F distribution is used by the facility to make a decision about how much deviation will be tolerated for a particular user in a particular environment.

At a block 680, the F value that is greater than 1 is used for purposes of the subsequent probability determination. At a block 690, the probability P₍ₚₐᵣₐₘₑₜₑᵣ₎ is derived based on the probability distribution function of the F statistic that is used. If the F value is greater than a pre-determined threshold, a score is produced and recorded. For example, if the score is above or equal to probability of 0.5, the facility may determine that the response authenticates the user. If the score is less than 0.5, the facility will fail to authenticate the user. The threshold score that authenticates or fails a user may be set based on the particular application in which the facility is being used. Once the probability is determined that the user being authenticated is the same user as that identified by the user profile based on the response parameters, the parameter probability component may be inserted into equation (1) above.

As reflected in equation (1), the probability based on the accuracy of the user's responses is multiplied by the probability based on the response parameters. The resulting overall probability P_{(cognitive)} is computed by the facility for the user that is seeking to be authenticated. If the overall probability exceeds a threshold set by the facility, the user is verified and allowed access to the protected resources. If the overall probability is less than the threshold set by the facility, the user is not verified and is denied access to the resources. It will be appreciated that the facility may adjust the authentication threshold depending on the user, the environment and location of the user, the type of device that is being used by the user, and the desired level of security. Such adjustment may be made in accordance with predefined rules or as a result of certain triggering events. The facility therefore allows a significant amount of flexibility when implementing different versions of a security solution.

Some embodiments of the facility employ all of the calculations leading to the MeanSquareOld determination above (i.e., equations 1-6), but then use an expected range parameter that compares current reaction time with the immediately preceding reaction time. The logic for these embodiments is that they allow the facility to dynamically predict how a user will respond based on the user's deviation pattern. For example, if a user has entered a very fast response (compared to how he or she normally responds) for column 3 of the 5^{th} session, the predicted response for the user will be slower for that column on the 6^{th} session. These embodiments use the outcome from all columns in the data table 500 to create a joint probability that the person entering the information is the predicted user, rather than the previously-discussed embodiments that compare the deviation pattern to the typical deviation pattern. The score for a particular user session may be calculated using the following equations:

$$\begin{matrix}if {RT}_{n - 1} - 0.5 * \sqrt{{MSO}_{n - 1}} \leq {RT}_{n} \leq {RT}_{n - 1} + 0.5 * \sqrt{{MSO}_{n - 1}} \\ then score = \frac{1}{\# of columns} * 1.0 & Eq . ( 10 ) \\ if {RT}_{n - 1} - 1.0 * \sqrt{{MSO}_{n - 1}} \leq {RT}_{n} \leq {RT}_{n - 1} + 1.0 * \sqrt{{MSO}_{n - 1}} \\ then score = \frac{1}{\# of columns} * 0.75 & Eq . ( 11 ) \\ if {RT}_{n - 1} - 1.5 * \sqrt{{MSO}_{n - 1}} \leq {RT}_{n} \leq {RT}_{n - 1} + 1.5 * \sqrt{{MSO}_{n - 1}} \\ then score = \frac{1}{\# of columns} * 0.50 & Eq . ( 12 ) \\ if {RT}_{n - 1} - 2.0 * \sqrt{{MSO}_{n - 1}} \leq {RT}_{n} \leq {RT}_{n - 1} + 2.0 * \sqrt{{MSO}_{n - 1}} \\ then score = \frac{1}{\# of columns} * 0.25 & Eq . ( 13 )\end{matrix}$$

Where MSO is the MeanSquareOld calculation, RT is the reaction time of the user, and # of columns is the number of columns of session data utilized from the data table.
III. Adaptive Capabilities

In some embodiments, after each successful authentication session the new response parameters measured in that authentication session may be stored in the user's profile and used in future sessions as part of the authentication process. Specifically, when calculating the MeanSquareOld variable as part of the process depicted in FIG. 6, the facility may utilize all of the response parameter data, or only a portion of the data, that is contained in a user's profile. Moreover, the facility may rely upon only early response parameter data (e.g., data associated with the initialization phase), late response parameter data (e.g., data stored from the last ten authentication sessions of a user), or a combination of data from selected timeframes. By focusing on certain portions of data, the facility may be tuned so that the recently measured response parameter data assumes a larger influence over the probability estimate than response parameter data received in the past. Those skilled in the art will appreciate that various weighting functions may also be introduced into the calculation in order to accomplish a similar objective. By relying more heavily on recent response parameter data, the system is more adaptive to changing user behavior.

In some embodiments, the use of equation (1) to calculate the probability of a user's identify may be enhanced to include additional forms of authentication. When additional forms of authentication are utilized to enhance the overall security of the system, the equation for calculating the probability that a user is authenticated may be more generally expressed as follows:
P₍ᵤₛₑᵣ₎=w₁P_{(Cognitive)}+w₂P_{(GLA)}+w3P_{(X)} Eq. (14)
Where w₁, w₂, and w₃ are weighting factors that collectively add to the value of one, P_{(Cognitive)} is the probability that the user has been verified based on the responses received and response parameters measured during an authentication session, P_{(GLA)} is the probability associated with global and local threat factors (as described in U.S. patent application Ser. No. 11/682,769, entitled “Globally Aware Authentication System,” filed 6 Mar. 2007, which is hereby incorporated by reference in its entirety) and P₍ₓ₎ is a probability variable that may pertain to any additional authentication method (e.g, biometrics) that may be added to strengthen the overall authentication testing. Typically, the first probability variable is more heavily weighted in the authentication process, and as a result bears a higher correlation with the outcome of the authentication session. By adding additional authentication methods in a linear fashion, the overall security of the system may be increased.

In some embodiments, the facility is able to identify the particular input device that is utilized by the user (e.g., mobile phone, laptop computer, PDA, etc.) and to correlate the input device with prior response parameters that were measured on that input device. For example, when the authentication session occurs on a mobile phone, only response parameters previously measured on the mobile phone (or on similar mobile phones) will be utilized. By utilizing prior data associated with a similar device, a greater authentication accuracy is achieved since there will typically be less variability in response parameter data when correlated with a single device type.

In some embodiments of the facility, the information stored in the user's user profile can be used to modify the presentation rate of queries, possible responses, or other data during the authentication session. The rate that data is presented to the user may be sped up or slowed down so that the presentation rate matches the user's own rate of information acquisition. For example, a user who has been authenticated many times in the past will typically be faster at responding to queries then a user who has not been authenticated before. The level of user-preparedness for the information that will be presented can therefore be estimated and used accordingly. The facility can calculate an expected rate of acquisition for the experienced user and allow information to be presented at a rate that approximates this expectation. For example, the queries or the responses may only be displayed for a limited period of time as believed necessary for the user. After the time has expired, the queries and/or responses would fade from view. The experienced user would be able to read and process the information in sufficient time to allow them to respond to the query. In contrast, someone attempting to breach the security system may or may not be able to read the information fast enough to respond prior to the information being removed from view. By modifying the presentation rate of queries, possible responses, or other data it is more difficult for others to gain unauthorized access.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

These and other changes can be made to the invention in light of the above Detailed Description. Details of the invention may vary considerably in its implementation details, while still being encompassed by the invention disclosed herein. Accordingly, the copes of the invention is defined solely by the claims that follow and the elements recited therein.

I/we claim:

1. A method of authenticating a user for access to a resource, the method comprising:
in an initialization phase:
presenting a verified user with a plurality of queries, wherein each of the plurality of queries is presented with a plurality of possible responses to the query; and
for each presented query, receiving a response from the verified user selected from the plurality of possible responses, recording a response parameter that is associated with the received response, and storing the received response and the recorded response parameter in a user profile; and
in an authentication session:
presenting one or more of the plurality of queries to an unverified user, wherein each presented query includes a plurality of possible responses to the query including the response to the query received from the verified user in the initialization phase;
for each presented query, receiving a response from the unverified user selected from the plurality of possible responses and measuring a response parameter that is associated with the received response;
calculating a probability that the unverified user responding in the authentication session is the verified user based on the received response to each presented query and the measured response parameter that is associated with each received response; and
authenticating the unverified user as the verified user if the probability exceeds a threshold.

2. The method of claim 1, wherein calculating the probability comprises:
comparing the received response to each presented query from the unverified user with the stored response to each presented query in the user profile in order to calculate a probability that the unverified user is the verified user; and
comparing the measured response parameter that is associated with each received response from the unverified user with the recorded response parameter that is associated with each received response in the user profile in order to calculate a probability that the unverified user is the verified user.

3. The method of claim 2, wherein the measured response parameter is compared by determining whether the measured response parameter that is associated with each received response from the unverified user belongs to the same statistical model as the stored response parameter that is associated with each received response in the user profile.

4. The method of claim 3, wherein the statistical model utilizes a mean squared calculation.

5. The method of claim 1, further comprising for an unverified user that has been authenticated as a verified user, storing the received response to each presented query and the measured response parameter that is associated with each received response in the user profile.

6. The method of claim 5, wherein calculating the probability comprises:
comparing the received response to each presented query from the unverified user with the stored response to each presented query in the user profile in order to calculate a probability that the unverified user is the verified user; and
comparing the measured response parameter that is associated with each received response from the unverified user with the recorded response parameter that is associated with each received response in the user profile in order to calculate a probability that the unverified user is the verified user.

7. The method of claim 6, where only a portion of the recorded response parameters in the user profile are utilized in determining whether the measured response parameter that is associated with each received response from the unverified user belongs to the same statistical model as the stored response parameter that is associated with each received response from the verified user.

8. The method of claim 7, wherein the portion of the recorded response parameters in the user profile that are utilized are the most recently-stored response parameters.

9. The method of claim 1, further comprising the step of filtering the response parameters measured from the verified user to remove any response parameters that are outside of an expected range.

10. The method of claim 1, wherein the response parameter is an elapsed time between the presentation of a query and the receipt of a corresponding response.

11. The method of claim 1, wherein the response parameter is a cursor path between the presentation of a query and the receipt of a corresponding response.

12. The method of claim 1, wherein the threshold may be varied depending on a desired level of security.

13. The method of claim 1, wherein the threshold may be varied depending on an environment in which the method is used.

14. The method of claim 1, wherein the threshold may be varied depending on a device type utilized by the unverified user to access the resource.

15. A method of authenticating a user for access to a resource, the method comprising:
presenting one or more queries to an unverified user, wherein each presented query includes a plurality of possible responses to the query;
for each presented query, receiving a response from the unverified user selected from the plurality of possible responses and measuring a response parameter that is associated with the received response;
accessing a user profile that contains, for each query presented to the unverified user, a stored response to the query and a stored response parameter associated with the query, wherein the stored response and stored response parameter are indicative of a verified user; and
determining whether the unverified user is the verified user by:
comparing the received response to each presented query with the stored response to the query; and
comparing the measured response parameter for each presented query with the stored response parameter.

16. The method of claim 15, wherein determining whether the unverified user is the verified user comprises calculating a probability that the unverified user is the verified user.

17. The method of claim 16, wherein determining whether the unverified user is the verified user comprises determining whether the calculated probability exceeds a threshold.

18. The method of claim 17, wherein the threshold may be varied depending on a desired level of security.

19. The method of claim 17, wherein the threshold may be varied depending on an environment in which the method is used.

20. The method of claim 17, wherein the threshold may be varied depending on a device type utilized by the unverified user to access the resource.

21. The method of claim 15, wherein comparing the measured response parameter with the stored response parameter comprises determining whether the measured response parameter for each received query belongs to the same statistical model as the stored response parameter that is associated with each query in the user profile.

22. The method of claim 21, wherein the statistical model utilizes a mean squared calculation.

23. The method of claim 15, further comprising for an unverified user that has been determined to be a verified user, storing the received response to each presented query and the measured response parameter that is associated with each received response in the user profile.

24. The method of claim 23, wherein comparing the measured response parameter with the stored response parameter comprises determining whether the measured response parameter for each received query belongs to the same statistical model as the stored response parameter that is associated with each query in the user profile.

25. The method of claim 24, where only a portion of the recorded response parameters in the user profile are utilized in determining whether the measured response parameter that is associated with each received response from the unverified user belongs to the same statistical model as the stored response parameter that is associated with each received response from the verified user.

26. The method of claim 25, wherein the portion of the recorded response parameters in the user profile that are utilized are the most recently-stored response parameters.

27. A method of adjusting an authentication session of a user based on prior authentication sessions of the user, the method comprising:
receiving a request from a user to be authenticated;
accessing a user profile associated with the user, the user profile containing stored responses to a plurality of queries and stored response parameters that are associated with the stored responses and which reflect a response time of the user; and
presenting one or more or the plurality of queries to the user, wherein the presentation of each query includes a plurality of possible responses to the queries and wherein the presentation of each query is modified based on at least a portion of the stored response parameters.

28. The method of claim 27, wherein the presentation is modified by displaying the one or more queries for a limited period of time.

29. The method of claim 28, wherein the limited period of time is approximately equal to the response time of the user.

30. The method of claim 27, wherein the presentation is modified by displaying the plurality of possible responses for a limited period of time.

31. The method of claim 30, wherein the limited period of time is approximately equal to the response time of the user.

32. The method of claim 27, further comprising receiving a response from the user to each of the one or more plurality of queries that were presented to the user and measuring a response parameter associated with each received response.

33. The method of claim 32, further comprising authenticating the user based on the received response to each of the one or more plurality of queries.

34. The method of claim 33, further comprising storing the response parameter associated with each received response in the user profile if the user is authenticated.

35. The method of claim 34, wherein the portion of the stored response parameters are the most-recently stored response parameters.
